(19) United States
(12) Patent Application Publication
(10) Pub. No.: US 2003/0236725 A1
(43) Pub. Date: Dec. 25, 2003

(54) Financial statement presentment systems and methods

(75) Inventors: William Hickox, Omaha, NE (US); Kenneth Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 10/180,251

(22) Filed: Jun. 25, 2002

(51) Int. Cl. G06F 17/60

(52) U.S. Cl. 705/35

(57) ABSTRACT

A method of presenting financial statements to a consumer includes receiving implementation profile information from a client, wherein the implementation profile includes instructions that define options from which consumers may choose how to receive financial statements. The method further includes storing a representation of the implementation profile information at a database associated with a host computer. The method also includes transmitting from the host computer to a consumer computer a file that includes the options, wherein the options include: receive the financial statement by mail; receive the financial statement electronically; and receive the financial statement both by mail and electronically. The method further includes receiving at the host computer from the consumer computer a selection of one of the options and storing a representation of the selected option. The method also includes processing a financial statement and transmitting the financial statement to the consumer according to the selected option.

### BACKGROUND OF THE INVENTION

This invention relates generally to the field of financial transactions, and in particular to financial transactions where one or more electronic records of the transaction are produced. More specifically, the invention relates to preparing financial statements summarizing the financial transactions and presenting the statements to customers.

Every day millions of financial transactions occur throughout the world. In most cases, electronic records of the transactions are created. For example, one common type of financial transaction involves the use of a presentation instrument, such as a credit card, a debit card, and the like. When such a presentation instrument is used to make a purchase, information stored on the card is often read by a point of sale device which creates an electronic record of the purchase. In the case of credit cards, the information read by the point of sale device along with the amount of the purchase may be routed through various other entities in order to complete the purchase. For example, the transaction information may be electronically sent to the merchant's bank or financial institution, to a card hold association, such as VISA or MasterCard, and to the issuer's bank or financial institution. Each of these entities may also store information regarding the transaction.

Periodically, the credit card users (herein customers) must be billed for their usage of their credit accounts. The advent of the Internet and electronic communication has enabled many additional options for credit issuing organizations to present financial statements to customers. Hence, this invention is related to presenting financial statements to customers.

### BRIEF SUMMARY OF THE INVENTION

Embodiments of the present invention thus provide a method of presenting financial statements to a consumer. The method includes receiving implementation profile information from a client. The implementation profile includes instructions that define options from which consumers may choose how to receive financial statements. The method also includes storing a representation of the implementation profile information at a database associated with a host computer and transmitting from the host computer to a consumer computer a file comprising the options. The options include: 1) receive the financial statement by mail; 2) receive the financial statement electronically; and 3) receive the financial statement both by mail and electronically. The method further includes receiving at the host computer from the consumer computer a selection of one of the options and storing a representation of the selected option. The method also includes processing a financial statement and transmitting the financial statement to the consumer according to the selected option.

In some embodiments, the method includes changing the option based on the instructions. Transmitting the financial statement to the consumer may include sending an electronic file to the customer that enables the customer to view the file electronically. The method also may include transmitting information to the customer relating to a plurality of accounts. The method may include displaying a payoff estimator that enables the customer to calculate payoff information relating to one or more accounts. Transmitting the financial statement to the consumer may include sending an email to the customer indicating that the financial statement is available online. The implementation profile information may include an instruction that consumers may receive financial statements both by mail and electronically for no longer than a specified period of time. The method also may include receiving from the consumer computer a request to receive a creditworthiness report from a credit reporting agency relating to the consumer. The method may include linking the customer to a credit reporting agency computer.

In some embodiments, the method also includes transmitting a request to a credit reporting agency server to receive the creditworthiness report, receiving the creditworthiness report, and transmitting the creditworthiness report to the consumer. The creditworthiness report may include a Fair Isaac & Co. (FICO) score. The method may include transmitting a file comprising offers available to the consumer based on the creditworthiness report. The method may include receiving a request from the customer to filter certain of the offers.

In some embodiments, a method of presenting financial statements to a customer includes receiving at a host computer a request from a customer computer to view a financial statement and transmitting a file comprising the financial statement to the customer computer, the file further comprising an option for the customer to view a creditworthiness score associated with the customer. The method also includes receiving at the host computer a request to view the creditworthiness score and transmitting a request for the creditworthiness score to a credit reporting agency server. The method further includes receiving the creditworthiness score at the host computer and transmitting the creditworthiness score to the consumer computer.

A system for presenting financial statements to consumers includes a host computer system and a database associated with the host computer system. The host computer system is configured to receive implementation profile information from a client. The implementation profile includes instructions that define options from which consumers may choose how to receive financial statements. The host computer system is further configured to store a representation of the implementation profile information at the database and transmit to a consumer computer a file comprising the options. The options include: 1) receive the financial statement by mail; 2) receive the financial statement electronically; and 3) receive the financial statement both by mail and electronically. The host computer system is further configured to receive from the consumer computer a selection of an option and store a representation of the selected option. The host computer system also is configured to process a financial statement and transmit the financial statement to the consumer according to the selected option.

In other embodiments of the present invention, a computer-readable medium having computer-executable instructions for performing a method of presenting financial statements to a consumer includes receiving implementation profile information from a client. The implementation profile includes instructions that define options from which consumers may choose how to receive financial statements. The method also includes storing a representation of the implementation profile information at a database associated with a host computer and transmitting from the host computer to a consumer computer a file comprising the options. The options include: 1) receive the financial statement by mail; 2) receive the financial statement electronically; and 3) receive the financial statement both by mail and electronically. The method also includes receiving at the host computer from the consumer computer a selection of an option and storing a representation of the selected option. The method also includes processing a financial statement and transmitting the financial statement to the consumer according to the selected option.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a system for presenting financial statements to customers according to embodiments of the present invention.

FIG. 2 illustrates a method of presenting financial statements to customers according to embodiments of the present invention, which may be implemented in the system of FIG. 1.

FIGS. 3A-3G illustrate a series of screen displays in a system for allowing customers to select their method of receiving financial statements according to embodiments of the present invention.

FIG. 4 illustrates a method of producing financial statements for customers according to embodiments of the present invention.

FIG. 5 illustrates a method of changing customers' options for receiving financial statements based on client instructions according to embodiments of the present invention.

FIG. 6 illustrates a method of providing customers with a creditworthiness report according to embodiments of the present invention.

### DETAILED DESCRIPTION OF THE INVENTION

Credit services may be established with essentially any type of person, entity, organization, business, or the like that wishes to take payments for goods or services in the form of a credit, and, for convenience of discussion, are generally referred to herein as “merchants”. Such merchants may process a credit transaction based on an account identifier presented at the time of payment. The account identifier is used to identify the account to which the credit will eventually be posted. In many cases, the account identifier is provided on some type of presentation instrument, such as a credit card, debit card, smart card, stored value card, or the like. Conveniently, the account identifier may be read from a point of sale device, such as those described in copending U.S. Application Nos. ______, entitled “SYSTEMS AND METHODS FOR PERFORMING TRANSACTIONS AT A POINT-OF-SALE,” filed Apr. 3, 2002, by Earney Stoutenburg, et al., the complete disclosure of which is herein incorporated by reference. However, the account identifier may be obtained in other ways, such as by visual inspection of the presentation instrument, by telephone, over the Internet, and the like.

The user account information is transmitted to a credit processing service that approves and processes the transaction information and provides payment to the merchant. The credit processing service includes at least one platform server that receives and processes the transaction information. One example of a credit processing service is the service provided by First Data Corporation, Greenwood Village, Colo.

The credit processing organization may provide credit processing services on behalf of many clients, such as banks, or other financial institutions, and the like, who wish to issue credit accounts to their customers. The customers may then use the accounts to transact with merchants.

Periodically, the credit processing organization produces financial statements that summarize transactions for customers and bill the customers at least a minimum amount based upon their usage of the credit account. The financial statements must be presented to the customer so that the customer may render payment. The present invention provides systems and methods for presenting financial statements to customers on behalf of clients

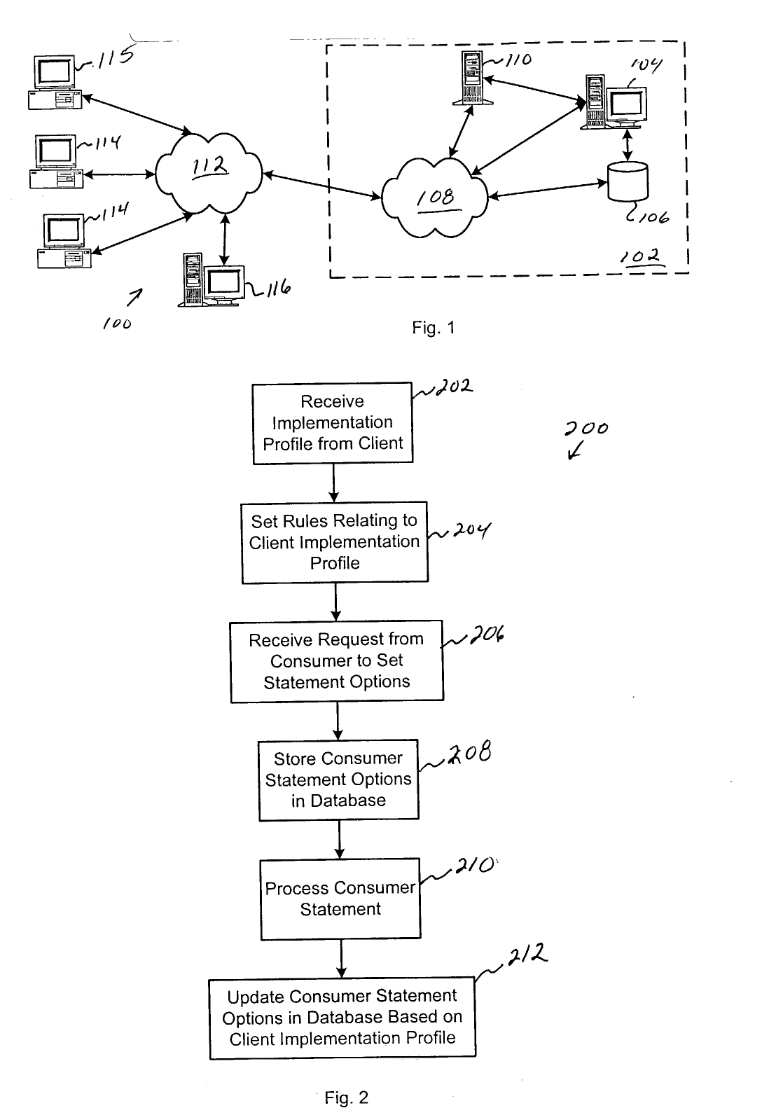

FIG. 1 illustrates one example of a system 100 for presenting financial statements to consumers according to embodiments of the present invention. It is to be understood that the system 100 is presented for illustrative purposes only and many other embodiments and equivalents are apparent to those skilled in the art in light of the disclosure herein. The system 100 includes a host computer system 102. The host computer system 102 includes a server 104 and a database 106 associated with the server 104. The server 104 may be any of a wide variety of well-known computing devices, including, for example, a personal computer, a workstation, a mainframe, a server, and the like. The database 106 may be any of a wide variety of storage devices, including, for example, magnetic storage systems, such as tape or disk, optical storage systems, such as CD or DVD systems, and solid state systems, such as RAM or ROM, and the like. The server 104 may be electrically connected for communication directly to the database 106. Alternatively or additionally, the server 104 and database 106 may communicate via a network 108. The network 108 may be any of a wide variety of network configurations, such as, for example, an intranet or a portion of the Internet. The network 108 may be, for example, a local area network (LAN), a wide area network (WAN), or the like. The host computer system 102 may also include a financial statement processing computer 110. The financial statement processing computer 110 may be any of a wide variety of well known computing devices. It may be connected to the server 104 directly or via the network 108. Many additional computing and data collection platforms (not shown) may be connected with the host computer system and/or be comprised by portions of it. For example, computers and databases may collect and store transaction information relating to activity for which financial statements are produced.

FIG. 1 also illustrates an external network 112 connected with the host computer system 102. The external network 112 may be, for example, the Internet or other network environment. Through the external network 112, customers are able to connect with the host computer system 102 using, for example, customer computers 114. Additionally, clients are also able to connect to the host computer system 102 using, for example, a client computer. FIG. 1 also illustrates a credit reporting agency server 116 connected to the host computer system 102 via the external network 112. The credit reporting agency server 116 may include one or more computers from which a customer may obtain information such as a FICO (Fair Isaac & Co.) credit score.

Having described the configuration of the system 100, the general operation of the system 100 will be described. More specific operation of the system will be described hereinafter with reference to the remaining figures. Financial transaction information is collected and stored using computers and storage devices associated with the host computer system 102. Periodically, the financial transactions are processed into financial statements for each customer by the financial statement processing computer 110. According to the present invention, customers have various options relating to how the customers will receive their financial statements (e.g., electronic, paper or both). However, the options available to the customers may be limited by the clients on whose behalf the statements are prepared. Instructions relating to the options available to customers are included in an implementation profile from each client that uses the services of the processing organization. The server 104, the database 106, and/or financial statement processing computer are appropriately programmed, or coded, based on the instructions in the implementation profile. Customers may access the host computer system 102 using customer computers 114 and select options for how they will receive their statements. The customers' selections are stored, for example at the database 106 or processing computer 110. Thus, when the financial statement processing computer 110 processes the statements, it uses the stored information to determine how the financial statements will be sent to the customers.

If a customer elects to receive his financial statement electronically, the server 104 or the processing computer 110 may cause an email to be sent to the customer. The customer may access the financial statement by connecting to the host computer system 102.

As the customer is viewing his statement, the host computer system 102 may present the customer with an option for requesting a creditworthiness report. If the customer requests a creditworthiness report, the host computer system 102 may send a request to the credit reporting agency server 116 and receive the report. The host computer system 102 then sends the report to the customer. Alternatively, selecting the option to receive a creditworthiness report may link the customer directly to the credit reporting agency server 116. Additionally, the host computer system 102 may send the customer offers available to the customer based on the customer's creditworthiness report. In some embodiments, the customer may have the option of either electing to receive offers or electing not to receive offers. In a specific embodiment, the customer may elect to filter certain offers. For example, a customer may wish not to receive offers intended for customers with sub-par creditworthiness when his credit is outstanding, or he may wish to receive only offers for lower mortgage rates, or the like. Other examples are possible.

It may be the case that clients of the credit processing organization desire particular options relating to how their customers may receive financial statements. For example, a client may allow its customers only a limited period of time for receiving both electronic and paper versions of their financial statements. The time period may be set to give the customer a period of time to become comfortable with receiving electronic statements, after which the customer must select either paper or electronic statements. Alternatively, the customer may be defaulted to either paper or electronic statements automatically, according to the instructions established by the client. Thus, the server 104 and/or processing computer 110 periodically may review the stored information according to the instructions provided by clients and change options as necessary.

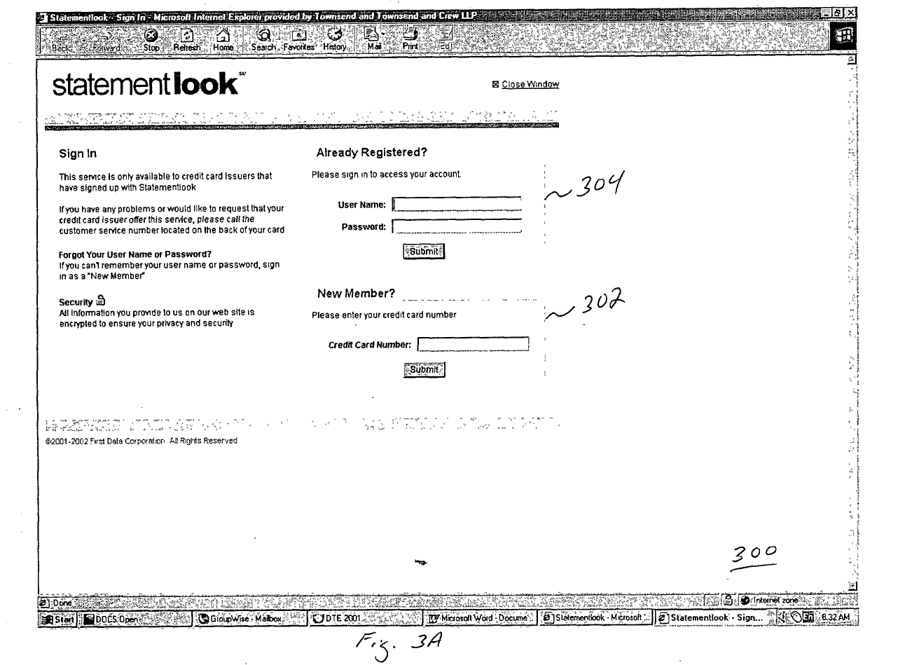

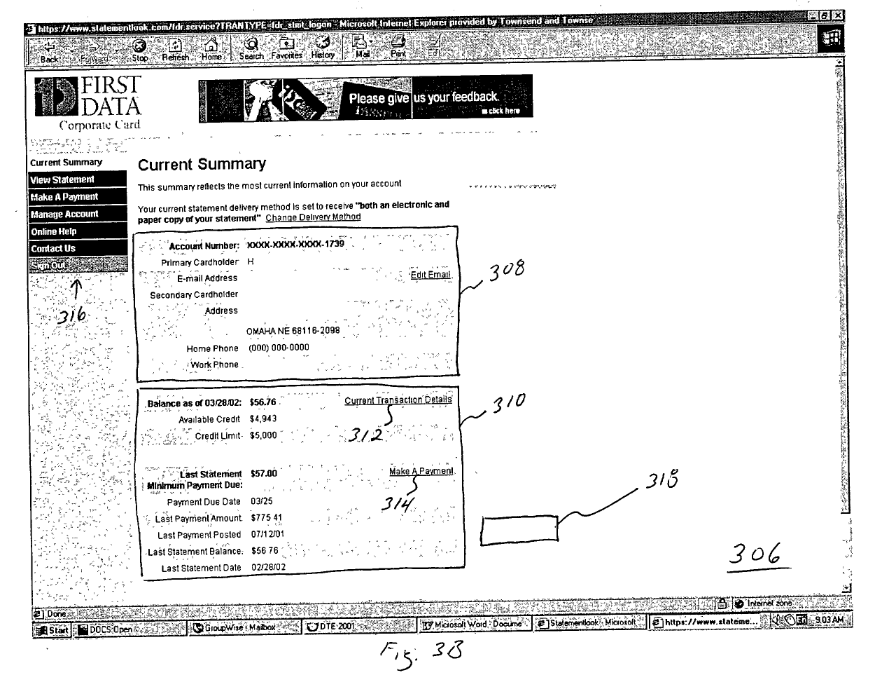

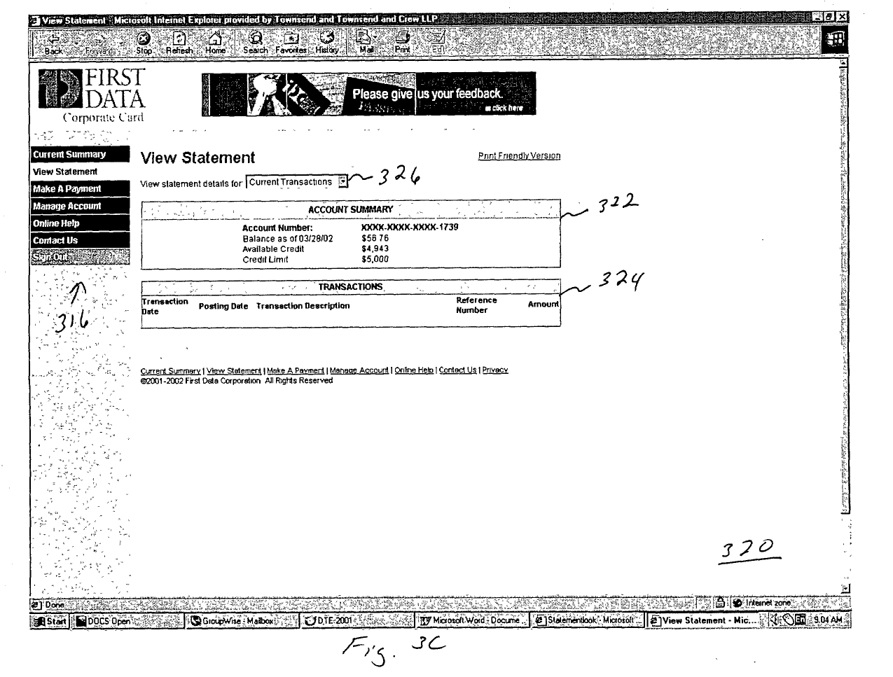

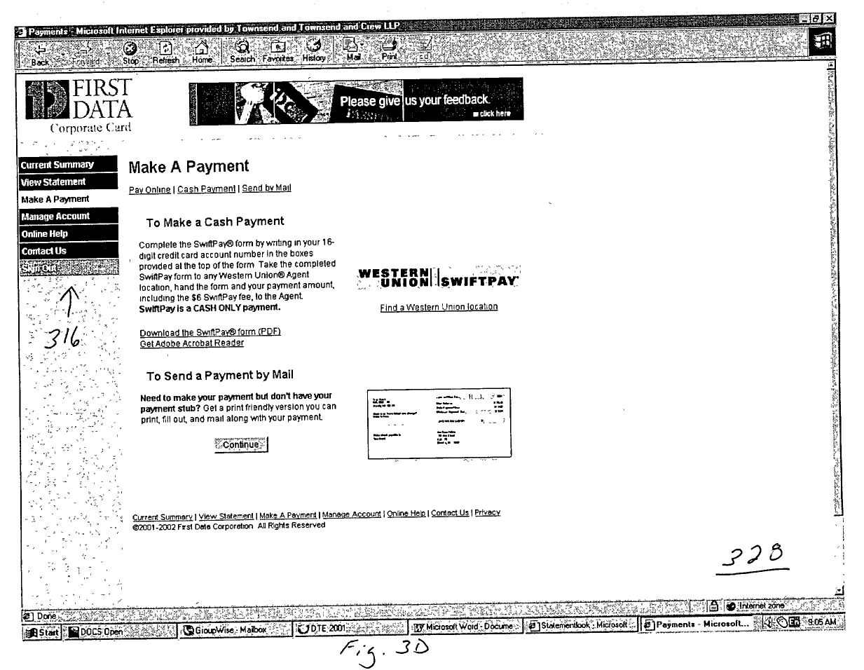

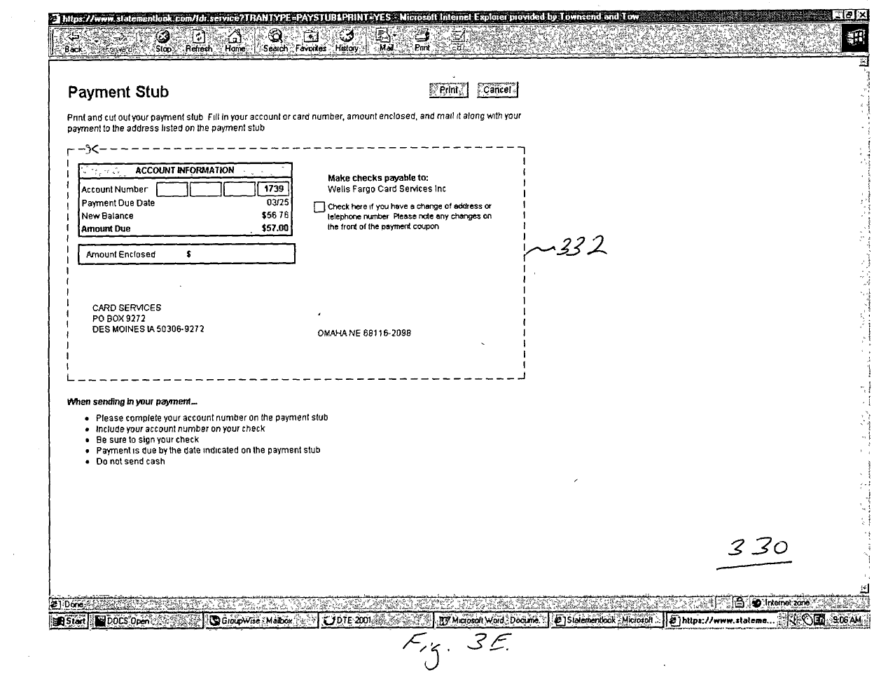

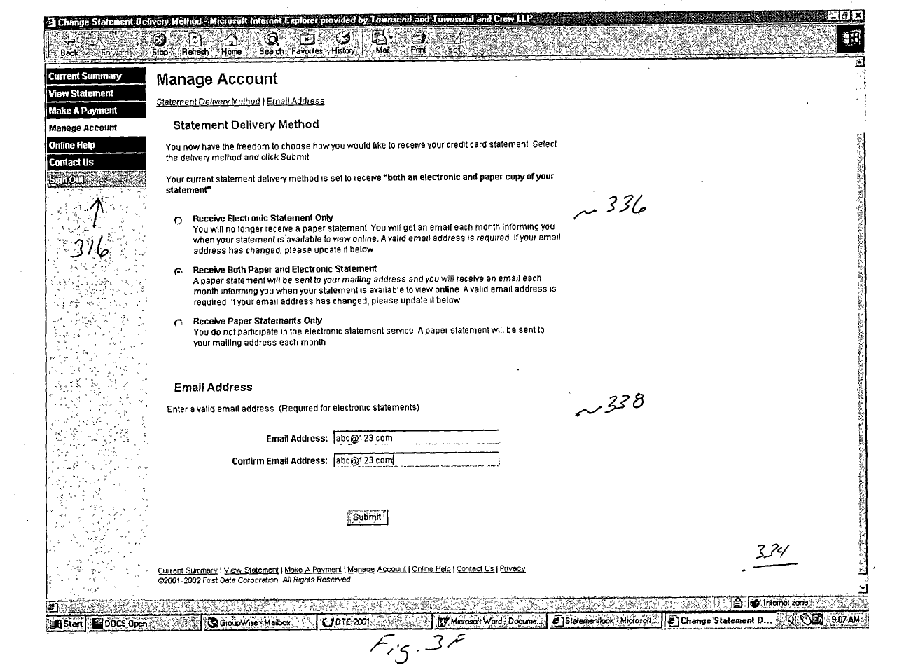

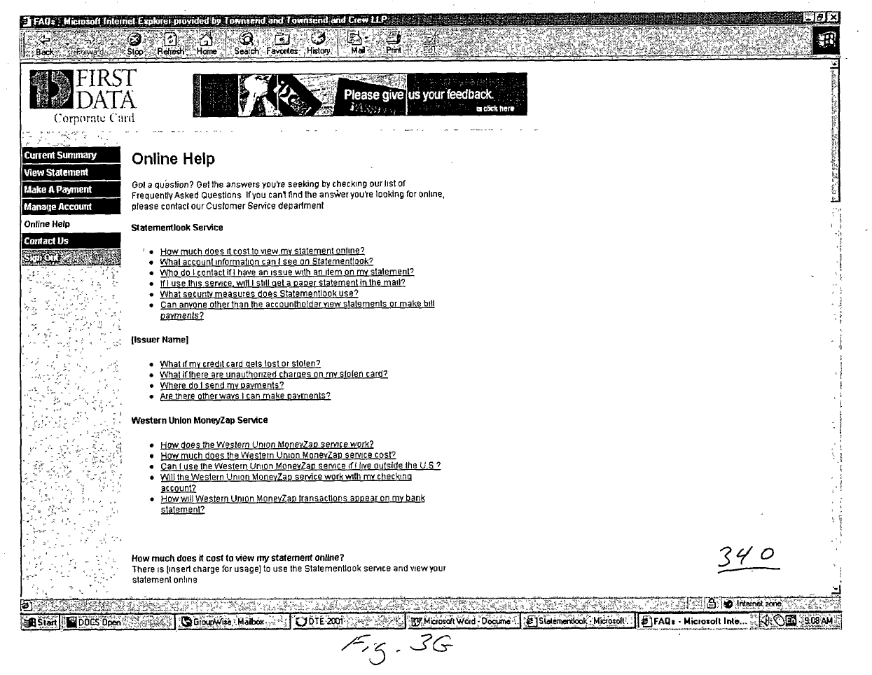

Attention is now directed to FIG. 2, which illustrates a method 200 for presenting financial statements to customers according to the present invention. At operation 202, the processing organization receives an implementation profile from a client. The implementation profile may be provided in paper form or electronically using, for example, the client computer 115. The implementation profile may contain instructions, as discussed above, for defining options available to customers for how customers may receive financial statements. For example, customers may receive financial statements electronically, by mail, or both. It may be the case that the credit processing organization has only a limited number of implementation profiles from which its clients may select. In other embodiments, the clients may design custom implementation profiles. At operation 204, rules are set in the system according to the implementation profile. At operation 206, a customer accesses the system and requests a particular option for receiving his financial statements. FIGS. 3A-3G illustrate a series of screen shots that a customer may view on his customer computer to view his financial statement and/or select options for receiving his financial statement.

FIGS. 3A-3G provide one example of screen displays a customer may view. Many other possibilities exist. The screen displays are illustrated within a typical web browser environment with familiar web browser navigation features. FIG. 3A illustrates a typical sign in screen display 300. The screen display 300 includes a new member area 302, and an existing member area 304. New members enter a credit card number into the field provided and, if the credit card number is valid and approved for online activity, the new member is taken through a registration process wherein the new user receives a user name and password. Standard security features may be provided for ensuring the account is only accessed by the user or persons authorized to access the account by the user. If the customer is an existing member, the customer enters his user name and password. Once valid information is provided, customers are taken to a summary screen 306, illustrated in FIG. 3B.

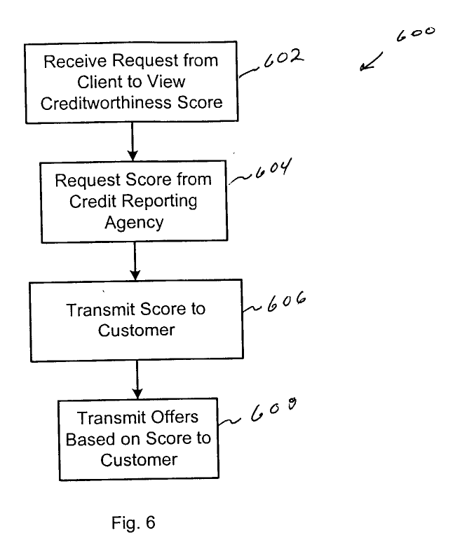

The summary screen 306 includes a basic information section 308 that identifies the account, the account holder and the account holder's contact information. The summary screen 306 also includes a financial statement area 310 that lists the customer's current balance, available credit and credit limit. Additionally, the financial statement area 310 lists information relating to the previous statement, the payment received, the amount due, and other relevant information. A button 312 allows the customer to view detailed transaction information. Another button 314 allows the customer to make a payment on line. A navigation area 316 includes additional buttons that allow the customer to access features of the site. In some embodiments, a credit score button 318 allows a customer to request a creditworthiness score from a credit reporting agency. This feature will be described in more detail hereinafter with reference to FIG. 6.

Selecting the view statement button in the navigation area takes the customer to the statement screen 320 illustrated in FIG. 3C. The statement screen 320 includes an account summary area 322 and a transactions area 324. A drop-down menu 326 allows the customer to view account summary and transaction information from the current statement period or from a previous statement period.

In some embodiments, the customer may view aggregate account information. For example, if the customer has multiple credit card and/or loan accounts accessible by the financial statement presentation system, in addition to being able to view each account individually, the customer may be able to view information relating to combinations of all accounts. Thus, the customer may be able to observe his entire outstanding debt. Further, in some embodiments, the system presents the customer with a “payoff estimator” that allows the customer to calculate the time and cost to pay off any one or combination of account balances based on a specified payment. The customer then may adjust the payment to evaluate alternatives for paying the balance(s) off according to different payment schedules.

Selecting the make a payment button in the navigation area 316 takes the customer to the payment screen 328 illustrated in FIG. 3D. The customer may select whether to make a payment online, make a cash payment using a wire transfer, make a cash payment at a money transfer location, or send a payment by mail. Selecting the option of paying by mail takes the customer to a payment stub screen 330, illustrated in FIG. 3E, from which the customer may print a personalized payment coupon 332 to send with a payment through the mail.

Selecting the manage account button in the navigation area 316 takes the customer to the account management screen 334 illustrated in FIG. 3F. The account management screen includes a statement delivery method area 336 and an email address area 338. In the statement delivery method area 336, the customer may select whether to receive statements by regular mail, online, or both online and by regular mail. These options are defined according to the client implementation profile discussed previously with respect to FIG. 2 and operation 206. Depending on the particular client implementation profile, the customer may be limited to receiving statements both online and by mail for only a particular period of time, as will be described further hereinafter. In the email address area 338, the customer provides email address information that allows the customer to receive a notification when his financial statement is available online, if he chooses that option. An online help screen 340 (FIG. 3G) is provided if the customer selects the online help button in the navigation area 316.

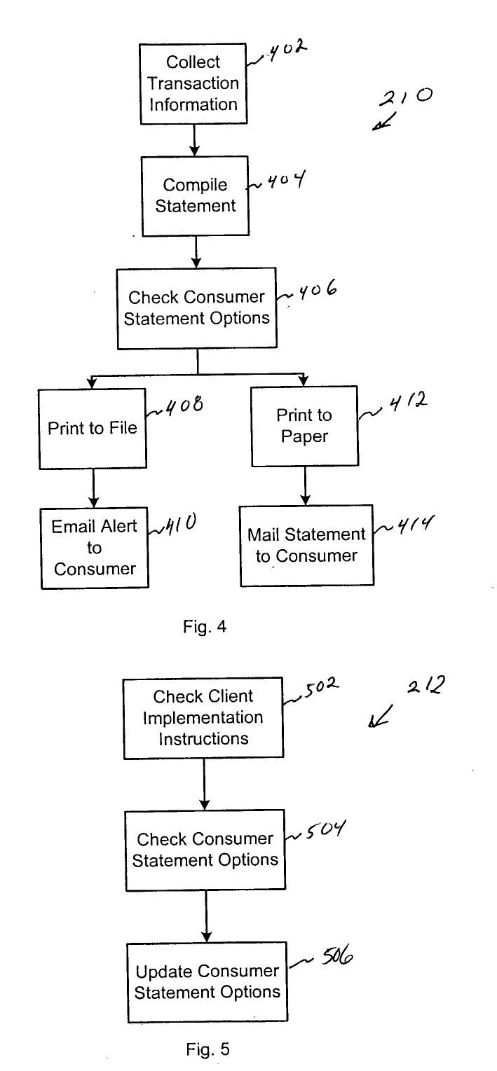

Attention is now redirected to FIG. 2. At operation 208, the customer's selection as to how to receive his financial statements is stored, for example, at the database 106 and/or the processing computer 110. At operation 210, the customer's financial statement is processed. Operation 210 will be discussed in further detail with reference to FIG. 4.

FIG. 4 illustrates operation 210 in greater detail. At operation 402, transaction information relating to the customer is collected. The information may be collected over a period of time using a number of computing platforms connected with the network 108. At operation 404, the information necessary to process the customer's statement is compiled at the financial statement processing computer 110. This information may include transaction information, account information, previous statement information, and financial statement option information. The information may be compiled and processed in a batch mode for any number of customers, or the information may be compiled and processed continuously for one or more customers and clients. Many other processing possibilities exist.

At operation 406, the customer's statement selection is checked, and processing continues accordingly. For example, if the customer has selected to receive financial statements online, the statement is printed to a file at operation 408, and an email is sent to the customer at operation 410 alerting the customer that his statement is available online. If the customer has selected to receive his statements by regular mail, then the statement is printed to paper at operation 412, and the statement is mailed to the customer at operation 414. Of course, if the customer has elected to receive statements both online and by mail, the statement is printed and transmitted by both means. Many other examples are possible.

Returning to FIG. 2, at operation 212, the customer's statement selection option may be changed based on the client's implementation profile. This operation is described in further detail with reference to FIG. 5.

FIG. 5 illustrates operation 212 in greater detail. Periodically, according to a client's implementation profile, it may be necessary to review and update customers' selections for receiving financial statements. For example, a customer may be permitted to receive both electronic and paper financial statements for only a limited period of time. Continuing with this example, a client implementation profile may include an instruction that customer's of the client may receive their statements by both means for only two months, after which time the customers are automatically switched to receiving financial statements only electronically. Thus, operation 212 may be executed periodically to update customers' selections accordingly. At operation 502, the client's implementation profile instructions are checked. Operation 502 may be executed simultaneously for several clients or may be executed for only one client at a time. At operation 504, selections for appropriate customers (i.e., customers of the clients selected in operation 502) are checked. In the current example, any customer having received both paper and electronic statements for more than two months is defaulted to electronic only at operation 506. Other changes may be necessary based on other rules. Clients may also provide their customers with an opportunity to return to paper statements at any time. In fact, clients may even provide customers with additional electronic trial periods, wherein their customers may receive both electronic and paper statements for an additional period of time.

Attention is directed to FIG. 6, which illustrates a process 600 for providing creditworthiness scores to customers. At operation 602, a customer selects, for example, the credit score button 318 of FIG. 3B, thus transmitting a request from the customer's computer to the host computer system 102 of FIG. 1. In response, at operation 604 the host computer system 102 transmits a request to the credit reporting agency server 116 to return the customer's creditworthiness score. At operation 606, the host computer system 102 transmits the score to the customer's computer. Alternatively, the creditworthiness score information may be obtained by linking the customer directly to the reporting agency server 116 or other computer associated with the reporting agency's system. Additionally, the host computer system 102 may transmit offers for other credit services based on the score, which the customer may select or view in greater detail. For example, a credit card company may wish to offer credit cards to individuals having at least a certain credit score. Other examples include offering extended grace periods, low or no interest promotions, mortgage or auto loans, and the like. This process has the advantage of providing the credit processing organization with enhanced marketing opportunities to reach customers directly and provide offers based on partial credit underwriting criteria. The customer also may have the option to filter the offers, as previously mentioned. In other embodiments, the customer may solicit offers based on his credit score. Other examples are possible.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to presenting financial statements relating to the use of credit services. For example, the present invention may be used to present utility bills, phone bills, mortgage statements, brokerage account statements, and the like. Accordingly, the above description should not be taken as limiting the scope of the invention, which is defined in the following claims.

What is claimed is:

1. A method of presenting financial statements to a consumer, comprising:
receiving implementation profile information from a client, the implementation profile comprising instructions that define options from which consumers may choose how to receive financial statements;
storing a representation of the implementation profile information at a database associated with a host computer;
transmitting from the host computer to a consumer computer a file comprising the options, wherein the options comprise:
1) receive the financial statement by mail;
2) receive the financial statement electronically; and
3) receive the financial statement both by mail and electronically;
receiving at the host computer from the consumer computer a selection of one of the options;
storing a representation of the selected option;
processing a financial statement; and
transmitting the financial statement to the consumer according to the selected option.

2. The method of claim 1, further comprising changing the option based on the instructions.

3. The method of claim 1, wherein transmitting the financial statement to the consumer comprises sending an electronic file to the customer that enables the customer to view the file electronically.

4. The method of claim 3, further comprising transmitting information to the customer relating to a plurality of accounts.

5. The method of claim 4, further comprising displaying a payoff estimator that enables the customer to calculate payoff information relating to one or more accounts.

6. The method of claim 1, wherein transmitting the financial statement to the consumer comprises sending an email to the customer indicating that the financial statement is available online.

7. The method of claim 1, wherein the implementation profile information includes an instruction that consumers may receive financial statements both by mail and electronically for no longer than a specified period of time.

8. The method of claim 1, further comprising receiving from the consumer computer a request to receive a creditworthiness report from a credit reporting agency relating to the consumer.

9. The method of claim 8, further comprising, linking the customer to a credit reporting agency computer.

10. The method of claim 8, further comprising:
transmitting a request to a credit reporting agency server to receive the creditworthiness report;
receiving the creditworthiness report; and
transmitting the creditworthiness report to the consumer.

11. The method of claim 10, wherein the creditworthiness report comprises a Fair Isaac & Co. (FICO) score.

12. The method of claim 10, further comprising transmitting a file comprising offers available to the consumer based on the creditworthiness report.

13. The method of claim 12, further comprising receiving a request from the customer to filter certain of the offers.

14. A method of presenting financial statements to a customer, comprising:
receiving at a host computer a request from a customer computer to view a financial statement;
transmitting a file comprising the financial statement to the customer computer, the file further comprising an option for the customer to view a creditworthiness score associated with the customer;
receiving at the host computer a request to view the creditworthiness score;
transmitting a request for the creditworthiness score to a credit reporting agency server;
receiving the creditworthiness score at the host computer; and
transmitting the creditworthiness score to the consumer computer.

15. The method of claim 14, further comprising transmitting offers available to the customer based on the creditworthiness score.

16. A method of presenting creditworthiness information to a customer, comprising:
receiving at a host computer a request from a customer computer to receive a creditworthiness score;
obtaining the creditworthiness score and transmitting it to the customer computer;
receiving a request from the customer computer to transmit offers available to the customer based on the creditworthiness score.

17. The method of claim 16, further comprising transmitting to the customer computer at least one offer available to the customer based on the creditworthiness score.

18. The method of claim 16, further comprising receiving a request from the customer computer to filter certain of the offers based specified criteria.

19. A system for presenting financial statements to consumers, comprising:
a host computer system; and
a database associated with the host computer system;
wherein the host computer system is configured to:
receive implementation profile information from a client, the implementation profile comprising instructions that define options from which consumers may choose how to receive financial statements;
store a representation of the implementation profile information at the database;
transmit to a consumer computer a file comprising the options, wherein the options comprise:
1) receive the financial statement by mail;
2) receive the financial statement electronically; and
3) receive the financial statement both by mail and electronically;
receive from the consumer computer a selection of an option;
store a representation of the selected option;
process a financial statement; and
transmit the financial statement to the consumer according to the selected option.

20. The system of claim 19, wherein the host computer system is further configured to change the option based on the instructions.

21. The system of claim 19, wherein the host computer system is further configured to transmit an email to the customer indicating that the financial statement is available online.

22. The system of claim 19, wherein the implementation profile information includes an instruction that the consumer may receive financial statements both by mail and electronically for no longer than a specified period of time.

23. The system of claim 19, wherein the host computer system is further configured to receive from the consumer computer a request to receive a creditworthiness report from a credit reporting agency relating to the consumer.

24. The system of claim 23, wherein the host computer system is further configured to:
request a creditworthiness report relating to the consumer from a credit reporting agency server; and
transmit the creditworthiness report to the consumer computer.

25. The system of claim 23, wherein the host computer system is further configured to transmit offers available to the consumer based on the creditworthiness report.

26. A computer-readable medium having computer-executable instructions for performing a method of presenting financial statements to a consumer, comprising:
receiving implementation profile information from a client, the implementation profile comprising instructions that define options from which consumers may choose how to receive financial statements;
storing a representation of the implementation profile information at a database associated with a host computer;
transmitting from the host computer to a consumer computer a file comprising the options, wherein the options comprise:
1) receive the financial statement by mail;
2) receive the financial statement electronically; and
3) receive the financial statement both by mail and electronically;
receiving at the host computer from the consumer computer a selection of an option;
storing a representation of the selected option;
processing a financial statement; and
transmitting the financial statement to the consumer according to the selected option.

27. The medium of claim 26, wherein the implementation profile information includes an instruction that consumers may receive financial statements both by mail and electronically for no longer than a specified period of time.

28. The medium of claim 26, further comprising changing the option based on the instructions.
